(19) United States
(12) Patent Application Publication
(10) Pub. No.: US 2005/0269293 A1
(43) Pub. Date: Dec. 8, 2005

(54) Seasoning method for etch chamber

(76) Inventors: Chen-Lung Fan, Hsin-Chu City (TW); Kai-Chih Chang, Hsin-Chu City (TW); Jih-Jse Lin, Yung-Ho City (TW); Jing-Kae Liou, Taipei Hsien (TW); Ta-Chin Chen, Hsin-Chu (TW); Srisuda Thitinun, Rathburana (TH); Sok-Kiow Tan, Fremont, CA (US)

Correspondence Address: BEYER WEAVER & THOMAS LLP, P.O. BOX 70250, OAKLAND, CA, 94612-0250, US

(21) Appl. No.: 11/141,978

(22) Filed: May 31, 2005

(30) Foreign Application Priority Data
Jun. 2, 2004 (TW) 093115794

(51) Int. Cl. C23F 1/00; B44C 1/22

(52) U.S. Cl. 216/67; 216/71; 216/74

(57) ABSTRACT

Disclosed is a seasoning method for an etch chamber for improving the passing rate, comprising the steps of: introducing a wafer or plural control wafers into the etch chamber; introducing reacting gases into the etch chamber; applying power to top and bottom electrodes of the etch chamber to plasmarize the reacting gases; and adjusting the gate valve of the etch chamber to 90 to 100% of the fully open position, thereby reducing the amount of by-products and eliminating the factors for reducing the passing rate. The seasoning method of this invention is based on a low pressure, high flow-rate sluicing mechanism, where the atmospheric flow and high vacuuming ability would remove the maximum amount of polymer particles and flaking from the etch chamber.

### CROSS-REFERENCE TO RELATED APPLICATIONS

This application claims priority under 35 U.S.C. § 119 of Taiwan Patent Application No. 093115794 filed on Jun. 2, 2004, and said application is incorporated herein by reference in its entirety.

### FIELD OF THE INVENTION

The invention relates to a seasoning method for a semiconductor fabricating chamber, particularly to one employed in the etch chamber for wafer fabrication.

### BACKGROUND OF THE INVENTION

For most etchers, the by-products of etching reactions (such as polymer) are commonly deposited over the inner walls of the etcher chamber. The deposition of such etching by-products is particularly significant in metal etching process. The amount of by-products being deposited over the chamber walls increases when subjecting a wafer to gradual etching in the chamber. The deposit may flake to cause the amount of particles within the chamber increases drastically when the amount of deposit has reached a certain degree, thereby contaminating the wafer. The above-described etching mode adopts the so-called polymerized mode or dirty mode, where a polymer layer is deposited over the chamber inner walls prior to the etching process and the polymer layer is preserved during the etching process until the next clean-up process. The etcher must be immediately shut down and subjected to wet clean when the amount of particles in the etch chamber or the number of defects exceeds the threshold values, thereby reducing the mean time between clean (MTBC). In addition, for etch chambers of the conventional etchers that are idle for more than 30 minutes or that need to be resumed for etching immediately after being subjected to wet clean, photoresist control wafers must be utilized for seasoning so as to tune the etcher to the optimum conditions. The cleaning and tuning require:

(1) Interference of engineers or operators while subjecting the etchers to wet clean, seasoning and testing, where shutting down the etchers and halting the normal fabrication process would increase the shut-down time and reduce the throughput; and

(2) Provision of additional photoresist control wafers for seasoning, which would burden the lithographic etchers with additional loads thereby increasing the manufacturing cost.

To overcome the above shortcomings, a waferless auto clean (WAC) that significantly increases the MTBC and reduces the amount of particles formed during etching process has been developed. Such a WAC utilizes O₂ and Cl₂ plasma to remove the deposit in the etch chamber subsequent to the etching of every individual wafer. The waterless auto clean is adapted to the so-called clean mode, where polymer residual in the etch chamber is kept to the minimum amount.

This invention may be employed in the dirty mode while achieving the objective of seasoning the etchers while removing the defects so as to improve the passing rate.

### SUMMARY OF THE INVENTION

It is a primary objective of this invention to provide a seasoning method for etch chamber capable of increasing the MTBC hours while reducing the defects so as to improve the wafer throughput.

To achieve the above objective, this invention discloses a seasoning method for etch chamber, comprising the steps of: introducing a wafer or plural control wafers into the etch chamber; introducing reacting gases into the etch chamber; applying power to top and bottom electrodes of the etch chamber to plasmarize the reacting gases; and adjusting the gate valve of the etch chamber to 90 to 100% of the fully open position.

The seasoning method of this invention is based on a low pressure (0 to 10 mT), high flow-rate sluicing mechanism, where the atmospheric flow and high vacuuming power would remove the maximum amount of polymer particles and flaking from the etch chamber. In addition, the seasoning method of this invention would also increase the power of the bottom electrode to approximately 150-350 W, for increasing the density of the etching by-products and reducing the formation of wafer defects.

The opportune timing for employing the above-described seasoning method includes when:

1. Resuming the etcher after clean-up;

2. Resuming the etcher after the etcher is idle for more than 30 minutes; or

3. The number of particles or defects in the etcher exceeds the threshold value.

This method may be employed in the dirty mode or clean mode.

### BRIEF DESCRIPTION OF THE DRAWINGS

These and other modifications and advantages will become even more apparent from the following detailed description of a preferred embodiment of the invention and from the drawings in which:

FIG. 1 is a structural schematic view of a metal etch chamber;

FIG. 2 is a flow chart illustrating the process of the seasoning method for etch chamber according to this invention;

FIG. 3 is a comparison chart illustrating the number of particle defects in wafers that are fabricated with and without performing the seasoning method of this invention;

FIG. 4 is a comparison chart illustrating the number of pattern defects in wafers that are fabricated with and without performing the seasoning method of this invention; and

FIG. 5 is a schematic view illustrating the pattern defects.

### LISTING OF NOMENCLATURES

10 metal etch chamber

11 electrostatic chuck

12 showerhead baffle

13 top electrode

14 wafer

15 chamber liner

16 apertures

17 gate valve

18 bottom electrode

### DETAILED DESCRIPTION OF THE PREFERRED EMBODIMENTS

To understand the technical features of this invention, the structure of an etch chamber is described as follows:

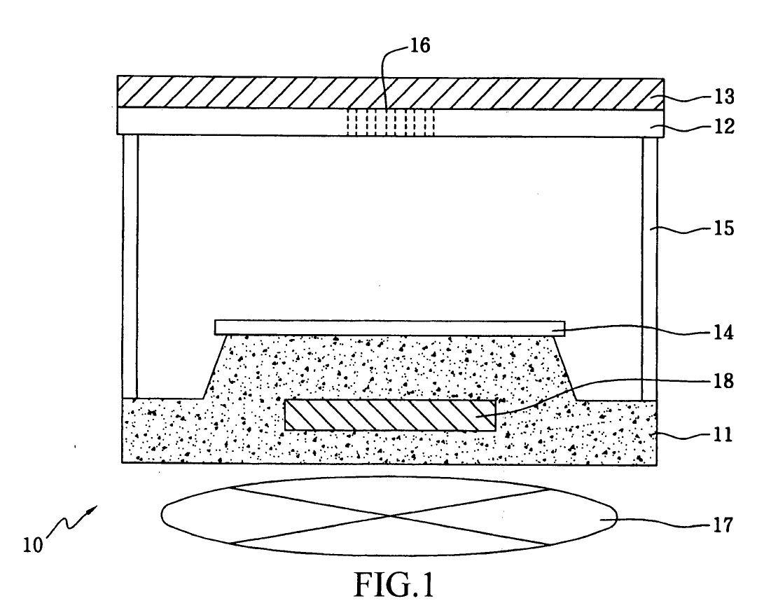

FIG. 1 is a structural schematic view of a metal etch chamber 10. The metal etch chamber 10 comprises: an electrostatic chuck (ESC) 11; a showerhead baffle 12; a top electrode 13 for generating Transformer Coupled Plasma (TCP); a chamber liner 15; a gate valve 17 and a bottom electrode 18. The electrostatic chuck 11 serves to mount a wafer 14, subjects the wafer to the etching process and includes the bottom electrode 18. The showerhead baffle 12 includes plural apertures 16 for introducing reacting gases into the chamber 10. The top electrode 13 applies power to the gases as introduced to plasmarize the gases. The chamber liner 15 confines the plasma in the chamber to prevent leakage of the plasma, where the liner 15 is replaced when the etcher is subjected to wet clean and the used liners 15 are cleansed separately to reduce the idle time. The gate valve 17 includes a lower end that is connected to a vacuuming pump (not shown), where the count of the gate valve may be adjusted to configure the open percentage. A larger value of count represents a higher open percentage and a higher vacuuming power applied to the chamber 10.

To reduce the amount of polymer flaking or particles, the seasoning method of this invention is based on a low pressure, high flow-rate sluicing mechanism. The fabrication recipe adopted by a preferred embodiment of the seasoning process of this invention is as follows:

Top electrode power (TCP): 400 to 1000 W;

Bottom electrode power (or bias power): 150-350 W, with a preference of higher power wattage;

Gases: Cl₂ at a flow rate of 160 to 300 standard cubic centimeters per minute (sccm), BCl₃ at a flow rate of 70 to 200 sccm, and a total flow of 230 to 500 sccm, with a preference of higher flow rate;

Helium gas pressure in the electrostatic chuck: 8 to 10 torr;

Gate open count: 900 to 1000 counts (where 1000 counts represent the fully open position), with a preference of 1000 counts;

Reaction time: 60 to 240 seconds, depending on the actual passing rate and suitable reaction time.

Other than the low pressure, high flow-rate mechanism, the power supplied to the bottom electrode 18 is higher than that as adopted in the conventional fabrication recipe so as to increase the density of the etching by-products (such as polymer), and to reduce the flaking of the polymer deposited over the chamber liner 15 or electrostatic chuck 11.

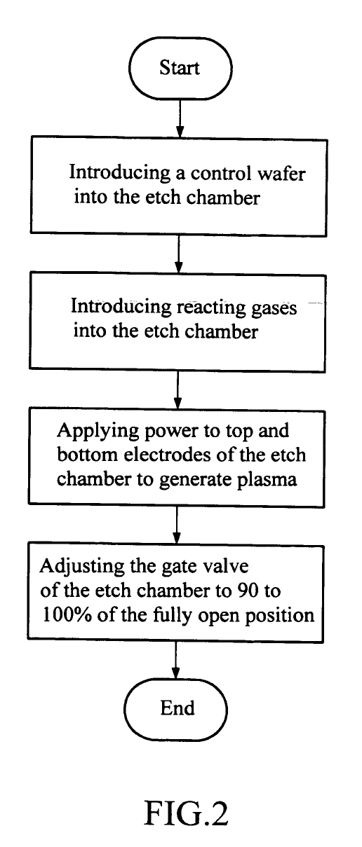

As for the sequence of seasoning, a control wafer is first introduced into the etch chamber 10; a mixture of the above-described reacting gases, including Cl₂ and BCl₃, is then introduced into the etch chamber 10; power is then applied to the top and bottom electrodes 13, 18 of the etch chamber to generate plasma; and the gate valve 17 of the etch chamber is adjusted to a position is practically fully open, such as 90 to 100% of the fully open position. As shown in the flow chart of FIG. 2, the high flow-rate sluicing mechanism and high vacuuming power would remove the maximum amount of polymer particles and flaking from the etch chamber to prevent formation of wafer defects.

The above-described seasoning recipe is performed after a fixed number of wafers has been etched, such as by placing a control wafer for seasoning purpose in a cassette and introducing the same into the etch chamber to perform seasoning of the etch chamber for every 25 pieces of wafers (one lot of wafers), for every 50 pieces of wafers (two lots of wafers) or for more than 50 pieces of wafers (more than two lots of wafers). In actual applications, the timing of seasoning may be configured to a location that is prior to or subsequent to etching of every batch of wafers, while the time of seasoning and number of control wafers subjected to seasoning are determined by the number of wafer products to be etched. Generally speaking, the time required for seasoning is proportional to the number of wafers to be etched, where the seasoning of the etch chamber may be achieved by extending the time of performing the seasoning recipe or increasing the number of control wafers to be employed in the seasoning process.

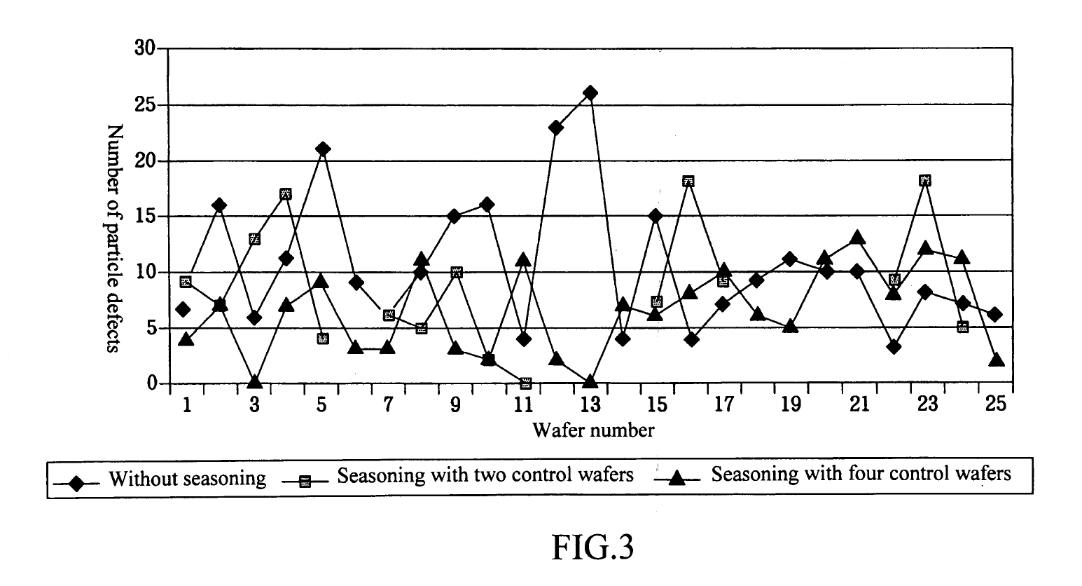

FIG. 3 reveals the comparison of particle defects found in wafers that are fabricated with and without performing the seasoning method by adopting the above-describe recipe of this invention. One may note from FIG. 3 that the number of particle defects found in the wafer that is fabricated without performing the seasoning method drastically fluctuates between 4 and 26, while the numbers of particle defects found in the wafers that are fabricated after seasoning the etch chamber with 2 or 4 control wafers are reduced to less than 20.

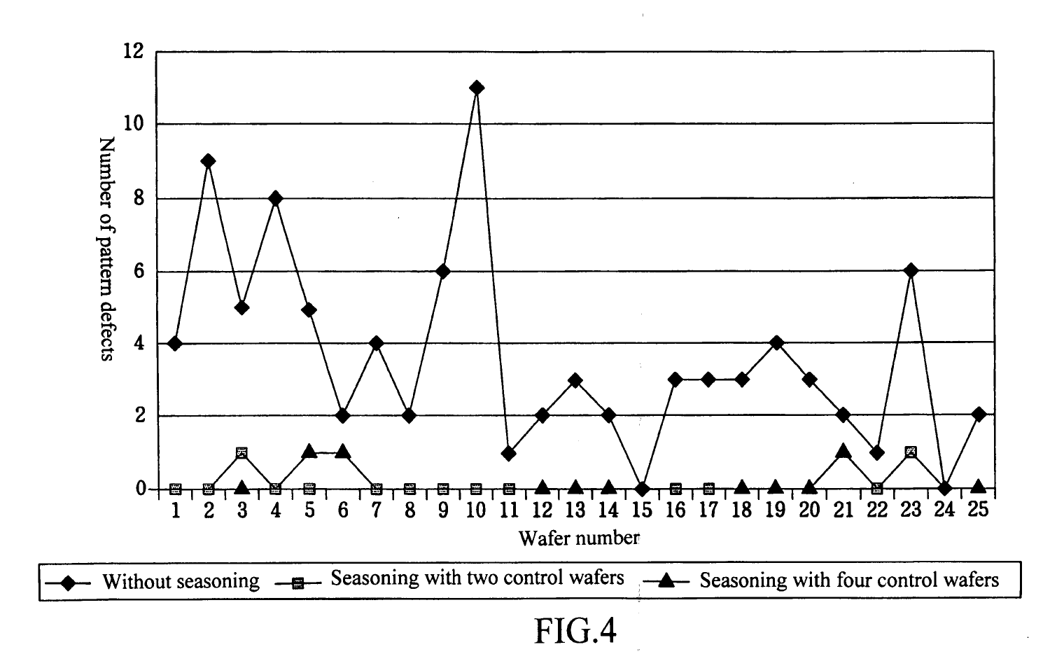

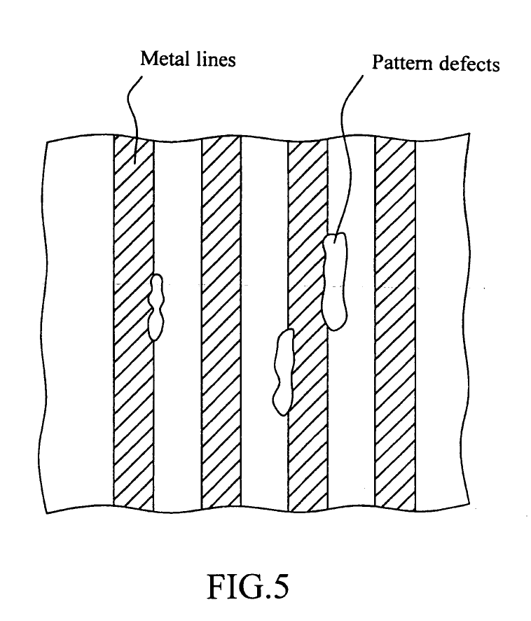

FIG. 4 reveals the comparison of pattern defects found in wafers that are fabricated with and without performing the seasoning method by adopting the above-describe recipe of this invention. The so-called pattern defects are polymer flaking in the form of stripes or blobs that are commonly found between the meal lines on the wafers, as shown in FIG. 5. One may note from FIG. 4 that the number of pattern defects found in the wafer that is fabricated without performing the seasoning method drastically fluctuates between 0 and 12, while the numbers of pattern defects found in the wafers that are fabricated after seasoning the etch chamber with 2 or 4 control wafers are significantly reduced to less than 2.

Obviously, the periodical implementation of the seasoning recipe of this invention can effectively reduce the number of defects on the wafers. In actual applications, the implementation of the seasoning recipe of this invention can increase the conventional MTBC plasma hours, which range from 30 to 50 hours, to 120 to 350 hours. Accordingly, not only can the seasoning method of this invention increase the passing rate of the wafer throughput, but also reduce the frequency required for clean-up and increase the up-time of the etcher.

The control wafers employed by the seasoning method of this invention may include the conventional pattern-free photoresist control wafers or control wafers with a heat oxidization layer, depending on the fabrication process employing the seasoning method.

The above description is exemplified by a metal etch chamber. However, Silicon Etch or Dielectric Etch chambers adopting the dirty mode or clean mode may also adopt the seasoning method of this invention to achieve the objectives of reducing the wafer defects and extending the MTBC hours.

This invention is related to a novel creation that makes a breakthrough in the art. Aforementioned explanations, however, are directed to the description of preferred embodiments according to this invention. Since this invention is not limited to the specific details described in connection with the preferred embodiments, changes and implementations to certain features of the preferred embodiments without altering the overall basic function of the invention are contemplated within the scope of the appended claims.

1. A seasoning method for an etch chamber, comprising the steps of:
introducing a control wafer into the etch chamber;
introducing reacting gases into the etch chamber;
applying power to top and bottom electrodes of the etch chamber to plasmarize the reacting gases; and
adjusting a gate valve of the etch chamber to 90 to 100% of a fully open position thereof.

2. The seasoning method for the etch chamber of claim 1, where the reacting gases have a total flow rate of 230 to 500 standard cubic centimeters per minute (sccm).

3. The seasoning method for the etch chamber of claim 1, wherein the reacting gases include Cl₂ and BCl₃.

4. The seasoning method for the etch chamber of claim 3, wherein the Cl₂ has a flow rate of 160 to 300 sccm, and the BCl₃ has a flow rate of 70 to 200 sccm.

5. The seasoning method for the etch chamber of claim 1, wherein the control wafer is a pattern-free photoresist control wafer.

6. The seasoning method for the etch chamber of claim 1, wherein the control wafer is a pattern-free control wafer with a heat oxidization layer.

7. The seasoning method for the etch chamber of claim 1, wherein the power applied to the bottom electrode ranges between 150 and 350 Watt.

8. The seasoning method for the etch chamber of claim 1, wherein the method is employed in a metal etch chamber.

9. The seasoning method for the etch chamber of claim 1, wherein the method is performed periodically during mass production of wafer by etching.

10. The seasoning method for the etch chamber of claim 1, wherein the top electrode adopts Transformer Coupled Plasma to plasmarize the reacting gases.

11. The seasoning method for the etch chamber of claim 1, wherein the method is employed in the dirty mode of etching process.
